(19) United States
(12) Patent Application Publication
(10) Pub. No.: US 2011/0225881 A1
(43) Pub. Date: Sep. 22, 2011

(54) METHOD OF PRODUCING AND ORGANIZING QUANTUM RESONANCE INTERFERENCE PULSES CAPABLE OF ALTERING MORPHOGENESIS WITHIN LIVING SYSTEMS AND A DEVICE FOR ACCOMPLISHING SAME

(76) Inventor: William Levengood, Grass Lake, MI (US)

(21) Appl. No.: 13/035,176

(22) Filed: Feb. 25, 2011

Related U.S. Application Data
(60) Provisional application No. 61/314,713, filed on Mar. 17, 2010.

(51) Int. Cl. A01G 1/00

(52) U.S. Cl. 47/58.1 SE; 47/58.1 R; 47/1.1 R

(57) ABSTRACT

A device and method for exposing vegetative biomaterial to the quantum resonance interference process to enhance at least one desired attribute of the treated vegetative material. The method includes the steps of subjecting vegetative biomaterial to a quantum interference field for an interval sufficient to interact with at least a portion of the biomaterial contained therein, and allowing the treated vegetative biomaterial to remain dormant for an interval prior to subsequent vegetative action.

### BACKGROUND

The invention disclosed herein pertains to methods and devices for producing and organizing quantum interference pulses capable of altering morphogenesis within living systems such as seeds, plants, and various microorganisms, and of enhancing vigor. More particularly, the present invention pertains to noninvasive methods and devices for treating living systems such as plants and seeds to yield plants exhibiting at least one of enhanced germination, enhanced biomass, enhanced disease resistance, enhanced weather resistance, enhanced fruit mass, and the like. The invention disclosed herein is also directed to biological systems such as seeds and plants exhibiting such attributes when treated by a method utilizing quantum interference.

There has been renewed interest in methods and processes that can be used on materials such as quiescent seeds and/or growing seedlings to alter and increase desirable attributes of the seed and/or plant that is produced. Such attributes can be expressed as one or more of increased germination rate, greater biomass output, disease resistance, drought resistance, increased growth or yield, cold or heat tolerance, tolerance to other environmental challenges, and the like. The need for plants and/or quiescent seeds exhibiting enhanced attributes has been long pursued and cannot be over-estimated. For discussion purposes, this will be referred to as enhanced vigor. Vigor can be expressed as any number of attributes including, but not limited to, at least one of increased germination rate and development, enhanced total plant biomass, increased fruit mass, increased resistance to disease, drought, cold, heat, or other environmental challenges. Enhanced vigor is becoming a more and more important attribute.

The need for healthy, high-yield crop plants is quite desirable in order to provide food for humans and animals. There is also a need for plants with greater masses of plant material such as leaf and stem material. Plants exhibiting greater biomass can result in greater resistance to environmental stresses such as drought, disease, and the like. Additionally, plants exhibiting greater biomass can also be particularly useful in the production of biologically derived fuels. It is also contemplated that plants exhibiting greater vigor may, in some instances, provide accelerated maturation cycles.

Heretofore, many, if not most, of the processes for increasing any aspect of plant vigor included processes such as chemical treatment, fertilization, genetic engineering, or the like. These procedures tend to be complicated, expensive, and yield a variety of undesirable byproducts. A variety of irradiation procedures have been proposed for disease control. However, the ability to treat seed materials using non-invasive procedures and non-invasive techniques in a manner that increases plant vigor has not been obtained.

It would be desirable to provide a method that can be employed on seed material in a manner that increases plant vigor. It is desirable that such a method be non-invasive as well as economical and capable of easy administration. It is also desirable that the method provide a device that is suitable for treating seeds in a manner that increases plant vigor and that uses non-invasive methods to provide seeds that are characterized by increases in plant vigor during at least one post-germination interval.

### SUMMARY

Disclosed herein is a device and method of treating living organisms that includes the steps of subjecting the organisms to a quantum resonance interference effect for an interval sufficient to perturb at least a portion of the metabolic material present in the organisms and allowing the organisms so treated to remain quiescent for an interval subsequent to treatment. In applications of the process involving un-germinated seeds, when the process is employed, the resulting germinated plants will exhibit increased attributes over control seeds and plants.

The process can be accomplished by producing a field of quantum resonance using quantum interference pulses and directing the pulses into living organisms such as seeds and/or growing seedlings.

### BRIEF DESCRIPTION OF THE DRAWINGS

The description herein makes reference to the accompanying drawings wherein like reference numerals refer to like parts through the several views and wherein:

FIGS. 1A and 1B are front and side views of the quantum resonance interference device according to a first embodiment as disclosed herein.

FIG. 2 is a graphic representation of the rapid decline in amplitude and uniformity of quantum pulses in the base plate, with the Meissner effect observed at d=2 cm, and not observed at 8 cm and 12 cm.

FIG. 3 is a graphic representation of results showing both positive and negative effects from the plasma resonance treatment on groups of 30 seeds and their resulting development factors (D_{f}) after 3 days. The (+) and (−) growth responses vary with the distance of the magnet above the seeds and are typical of the variations one observes in a resonance effect. Each point on the graph indicates the (D_{f}) derived from 30 seeds per test.

FIG. 4 is a graphic representation illustrating the correlation between (D_{f}) and corn seedling biomass at the 12-day development stage.

FIGS. 5A, 5B and 5C are various views of a schematic diagram of the arrangement of multiple magnets used in the air plasma resonance device according to an embodiment of the invention as present herein.

FIG. 6 shows results independently obtained by an independent testing facility displaying data obtained from seeds at the 8-day development stage. These seeds were treated with the Quantum Interference process as outlined herein, and after the 30-day waiting period, were submitted to the independent test facility for independent verification of the efficacy of the quantum interference process. This figure shows the effect of the pendulum magnet, at varying distances, on the (D_{f}) in corn seeds. The percent change in (D_{f}), which increases with distance (d), presents a high correlation fitting the mathematical model of a 4^{th} order polynomial.

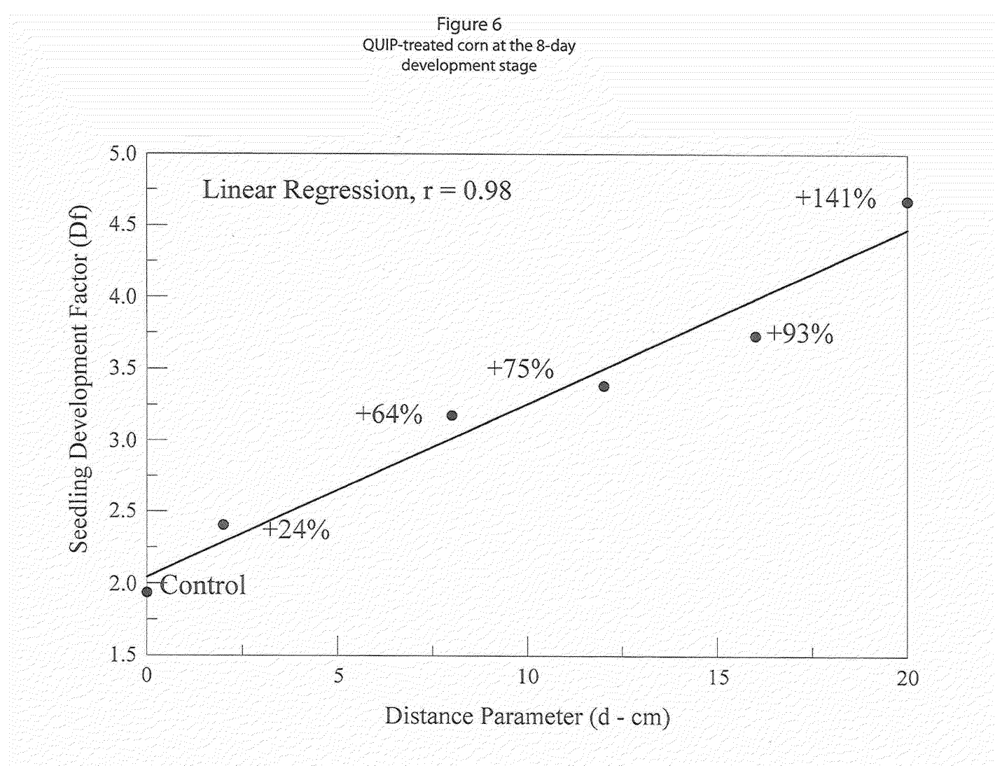

FIG. 7 is a graphic depiction of visual assessment data of the seedlings of FIG. 6 in the sense that at the 8-day development stage, the same sets of seedlings that were shown in FIG. 6 were examined by the independent test facility for the purpose of expert visual evaluation. In the controls, which were not exposed to the process disclosed herein and which are shown here as 0 on the abscissa, the degree of abnormal plant development was at 35%. However, in the treated seeds, the percentage of abnormal seedlings dropped to 7% with increasing distance (d) of the magnet above the baseplate.

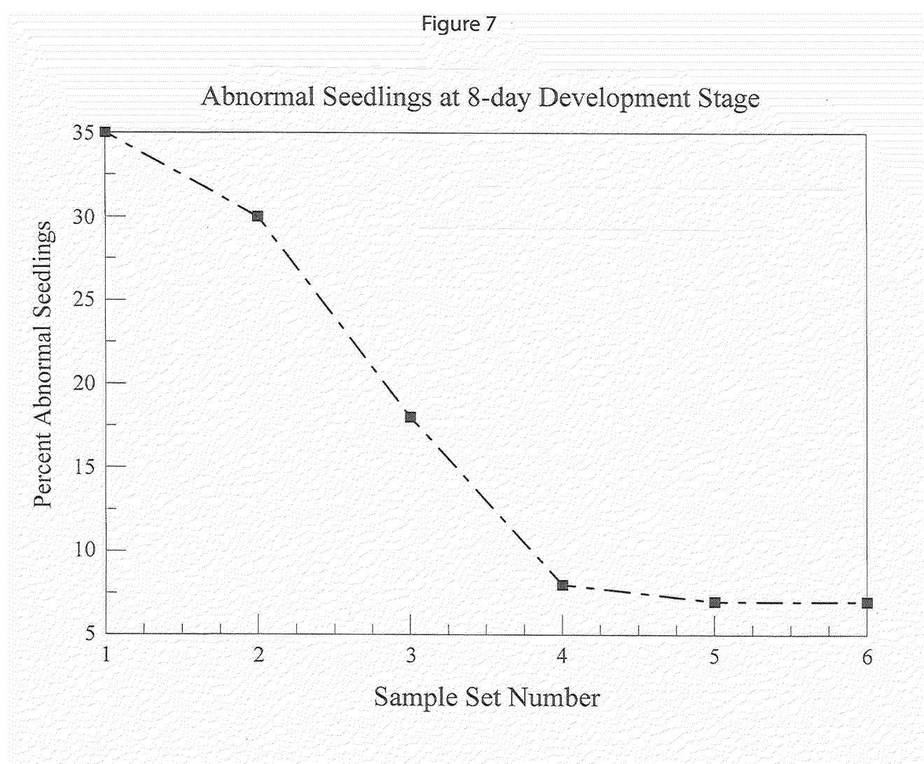

FIG. 8 shows the use of a single magnet for the QUIP exposure of seeds according to a current embodiment of the invention as presented herein.

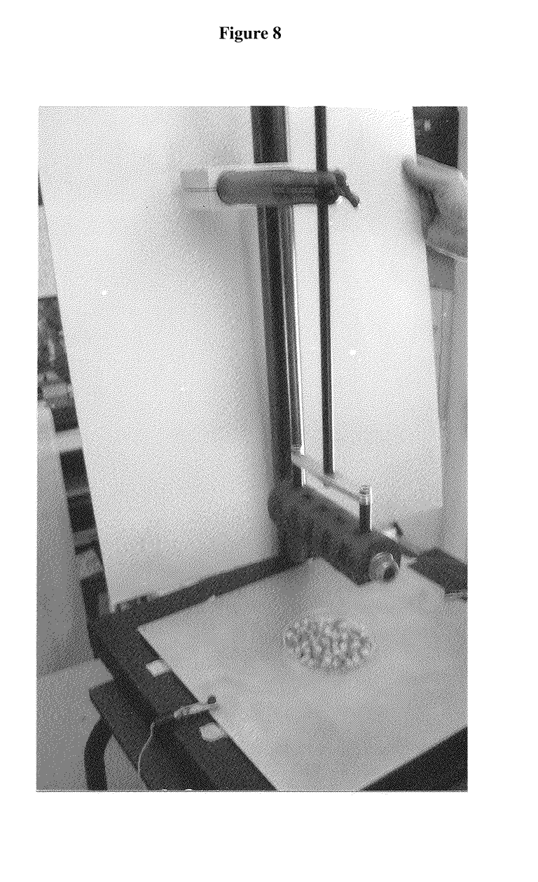

FIG. 9 shows the arrangement of multiple magnets used in the QUIP exposure of seeds according to a current embodiment of the invention.

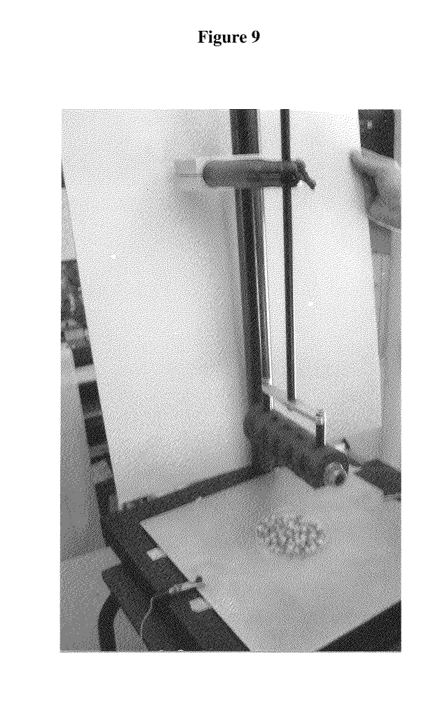

FIG. 10 shows two sets of corn seeds: on the left of the photo is the control set, and on the right side of the photo is the set of seeds treated by the QUIP process.

### DETAILED DESCRIPTION

The present disclosure pertains to a process for enhancing at least one feature or attribute of living organisms such as vegetative material by exposing that material to quantum resonance interference pulses for an interval sufficient to perturb at least a portion of the organism's vegetative metabolic system. The present disclosure also pertains to a quantum interference device configured to treat seeds, seedlings, and other biomaterial according to the method disclosed herein.

As used herein, the terms “organism” and “living organism” are construed to include plant material as well as living microorganisms. As used herein, the term “plant material” is construed to include seeds as well as newly germinated seedlings, and microorganisms such as yeast. The organisms to be treated by the device and method disclosed herein can be any suitable living material capable of respiration and exhibiting metabolic activity. Suitable organisms include, but are not limited to, various seed species, newly germinated seeds, seedlings, and microorganisms. It is also contemplated that the process could be employed on various bulbs, tubers, and the like, if desired or required. It is also contemplated that the process could be employed on materials used to grow plant tissue in certain embodiments with beneficial results. It is also contemplated that, in certain embodiments, the device and method as disclosed herein can be employed on various other growing plant material.

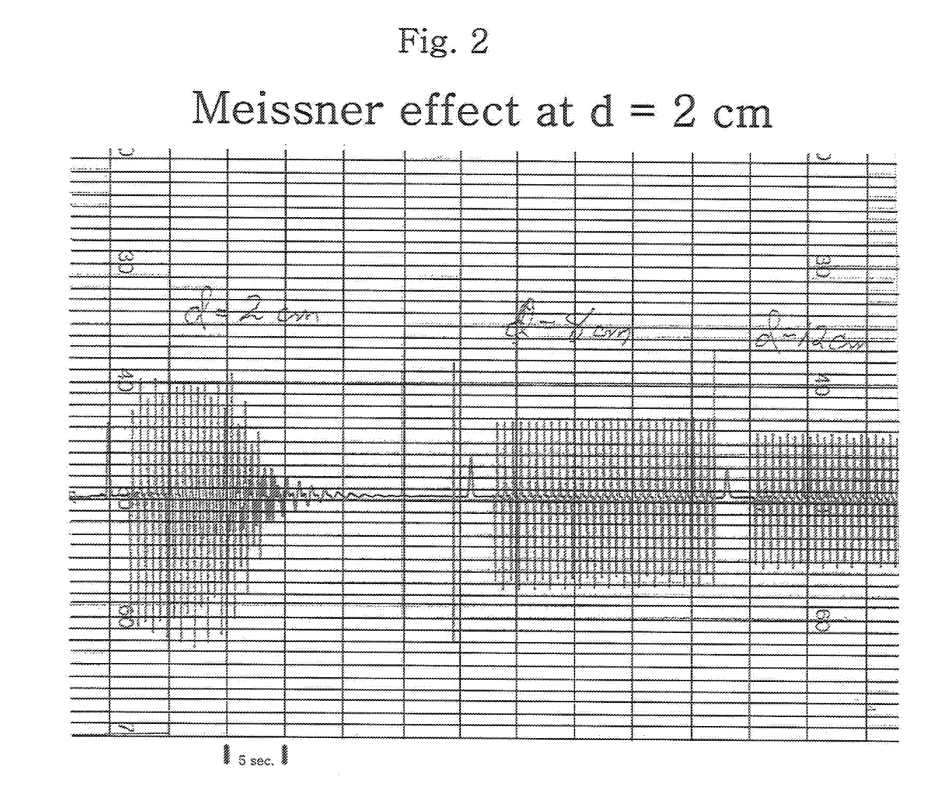

The general process as defined herein is designated as the “Quantum Interference Process.” By producing resonance in quantum interference pulses and directing these pulses into living organisms such as quiescent seeds or growing seedlings, the rates of germination, growth, biomass output, disease resistance, drought resistance, and cold tolerance are significantly improved. The frequency and amplitude of the resonant pulses are generated by a suitable device such as a pendulum with one, or more, high field strength magnets mounted at the end of a swing arm that is attached to a fulcrum point on a pendulum assembly. This pendulum assembly system is positioned above a baseplate. The baseplate can be composed of suitable material. A non-limiting example of such material is aluminum. With each swing of the pendulum-magnet system, its field induces what appears to be the formation of Cooper-pair electron waveforms in the baseplate. These electron waves are coherent and the uniformity of their amplitude is shown in FIG. 2. It should be noted that the trace reproduced in FIG. 2 of the movement of the magnet when it gets down to 2 cm above the baseplate. It has been found that the dampening effect is completed within 16 seconds from the time the magnet begins oscillating.

The quantum wave nature of these electron pulses is confirmed in two ways as follows:
a) In one example of the method disclosed herein, the pendulum, mounted on a frame constructed of non-magnetic material, had a 30 cm swing arm, and mounted at the end of the arm was a cylindrical magnet approximately 2.5 cm long and 2 cm diameter with a field strength of 1.25 Teslas. The magnet was mounted vertically with one pole facing downward. The frequency of the pendulum swing was approximately 0.8 Hz. The amplitude of the plasma pulses is related to the distance (d) between the pole face of the magnet and the baseplate. In the situation discussed here, it was found that if the magnet was under free swing with the (d) greater than 4 cm, the natural decay of the pendulum is around 16 minutes. If (d) is reduced to 2 cm or less, the swing is completely damped in 15 seconds or less (See FIG. 2).
   This severe damping is due to what is known as the Meissner effect, generally only observed in superconducting materials held near 0° K. The Meissner effect occurs when there is quantum entanglement between the external magnetic field of the pendulum magnet and the magnetic fields that build up inside the baseplate. Without being bound to any theory, it is contemplated that the high level of entanglement between the external field of the magnet and the internal magnetic fields in the baseplate is produced by the organization and coherence of the quantum particles hypothesized to be Cooper-pair electrons; this occurs within the crystal structure of the baseplate in spite of the fact that material such as aluminum is listed in all physics handbooks as being non-magnetic.
b) It is well-documented in the scientific literature that surface barriers such as roughness due to machining can influence the formation of quantum particle movements within superconductors. To test for this barrier effect, the room temperature pulses were examined using the same pendulum apparatus as described in section 1 above. The baseplate was replaced with a spectral photometric diffraction grating made by depositing an aluminum film on a flat glass plate. The grating was ruled at Johns Hopkins University in the 1950s using a diamond to create a ruling density of 14,000 lines per inch.
   The grating was placed under the pendulum system described in Section 1. The amplitude in microamps of the pulses obtained with the pendulum direction both parallel and perpendicular to the grating lines are as follows:

| Pendulum direction | Average | Sd. | N-pulses |
|---|---|---|---|
| Parallel with the grating lines | 0.160 | 0.028 | 20 |
| Perpendicular to grating lines | 0.049 | 0.002 | 16 |

When the ruling lines on the grating were perpendicular to the passage of the electron pulses, they formed a partial barrier and the amplitude of the pulses was decreased about 70%. This is additional evidence that the organized electron pulses have properties that are sensitive to surface barriers in a manner similar to the charge carriers involved in superconductors.

The invention disclosed herein presents a non-invasive method for enhancing development and vigor in biological materials such as plants and microorganisms. When this invention is used to treat seeds by exposing them to specific quantum resonance field energies for a sufficient interval, the resulting plants exhibit any number of positive attributes including, but not limited to, an increase in germination rate, growth rate, total plant biomass output, enhanced disease resistance, reduced abnormalities in the growing seedlings, increased cold tolerance, increased drought resistance, increased fruit mass, and increased yield. The need for such plants cannot be over-estimated, and healthy, high-yield crop plants are quite desirable in order to provide food for humans and animals. There is also a need for plants with greater masses of plant material such as leaf and stem material. Plants with greater biomass can have greater resistance to environmental stresses such as drought, disease, and the like. Additionally, plants exhibiting greater biomass can also be particularly useful in the production of biologically-derived fuels. It is also contemplated that plants exhibiting greater vigor may, in some instances, provide accelerated maturation cycles.

Heretofore, many—if not most—of the methods for increasing any aspect of plant vigor included processes such as fertilization using chemical treatments, genetic engineering, or the like. These procedures tend to be complicated, expensive, and many of them yield a variety of undesirable by-products and negative side-effects to the environment. A number of irradiation procedures have been proposed for disease control, however, the ability to treat seed material using non-invasive procedures and techniques in a manner that increases plant vigor has not been obtained. Thus, it would be very desirable to provide a method that can be employed on seed materials in a manner that increases plant heath, vigor, and yield output. It is also desirable that such a method be non-invasive as well as economical and capable of easy administration. It would be desirable to provide a device that is suitable for treating seeds in the manner described above, and to supply seeds treated by non-invasive methods that are characterized by increases in plant vigor during at least one growing interval or harvest season.

Obtaining Quantitative Information from Seed and Plant Growth Data

In the present disclosure, the term “Development Factor” or (D_{f}) is used to quantify the degree of positive or negative development within a given test set of seeds or seedlings as compared with a control set. The Development Factor may be described as a method of precision monitoring of growth responses during germination or seedling development.

In most test sets (30 seeds per set), either standard paper roll or Petri dish germination methods were employed. After treatment, the test sets (along with a non-treated control set) were placed in a germination chamber held at 25° C.

At the onset of germination, (3-4 days, depending on the seed species) the total seedling length of the emerging cotyledon is determined. Since both the percent germinated and the seedling height are important parameters for evaluating growth potential, the Development Factor (D_{f}) was employed. This is:

D_{f}=F_{g}×Lₛ (1)

Where F_{g} is the fraction germinated, and Lₛ is the mean seedling length (either hypocotyls, or total seedling length including roots) within a given test set.

The present disclosure details the basic design of a quantum interference device configured to treat seeds, seedlings, and microorganisms, and discusses seeds and seedlings that have been treated according to the method disclosed herein. In the device and method disclosed herein, the seeds and seedlings are exposed to a quantum resonance field for an interval sufficient to elicit positive morphogenetic changes as a response to the induced pulses of electron waves.

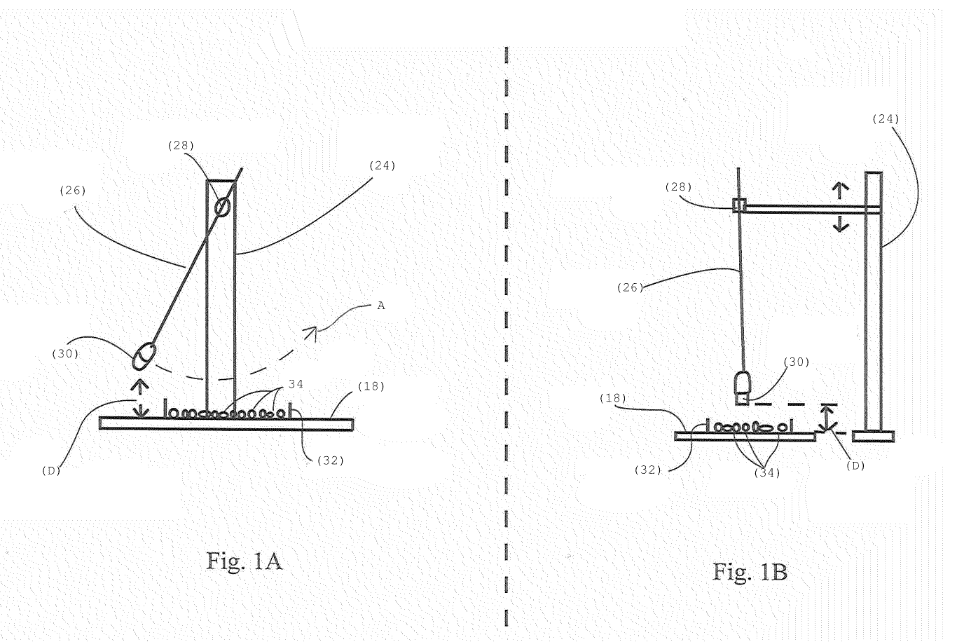

The quantum interference device as disclosed herein can be configured as depicted in FIG. 1. The device (10) includes means for generating quantum energy pulses. In the embodiment disclosed herein, the means for generating quantum energy pulses includes at least one suitable permanent magnet (30), or magnet array. The magnet is mounted or positioned in the device such that a periodic magnetic pulse can be produced. In the embodiment disclosed, the magnet or magnet array is mounted on a swing arm (26) suspended over a baseplate (18) in a manner sufficient to create a treatment field that acts on suitable biomaterial (34). The baseplate (18) is composed of a suitable material such as aluminum. The device will be designed in a manner suitable to create the desired effect. In one configuration, the baseplate is 30 cm L×30 cm W×0.3 cm thick.

Without being bound to any theory, it is believed that oscillating magnetic fields from the magnet attached to the pendulum cause the formation of electron wave pulses near the surface of the baseplate, and these pulses produce quantum energy fields that can either constructively or destructively interfere with the material being exposed. The photometric diffraction grating mentioned above was used to show that these pulses are generated very close to the surface of the baseplate. Further proof of the surface production of pulses was shown when the pendulum got too close to the baseplate causing quantum entanglement and demonstrating the Meissner effect, which resulted in the complete stopping of the oscillating magnet within seconds. When the pendulum swings back and forth over the baseplate, it generates electron wave pulsations in the surface of the baseplate, and these pulsations interfere with the molecular resonances in the seeds or other biomaterial being exposed, thus stimulating changes in their vigor and morphogenesis.

The portion of the device known as the pendulum assembly (24) will be of adjustable height and is positioned above the baseplate (18) in such a way that seeds and seedlings (34) can be placed directly on the baseplate (18), or in a suitable container (32) such as a Petri dish placed on the baseplate. In the embodiment depicted in FIG. 1, this is accomplished by utilizing a suitable pendulum assembly (24) that includes a swing arm (26) with one end mounted to a suitable pivot or fulcrum (28). At least one suitable magnet (30) can be mounted at the end of the swing arm. The swing arm can be of any suitable length that allows the magnet (30) to be positioned an optimum distance from the baseplate (18) with the seed or plant material (34) interposed between magnet and baseplate.

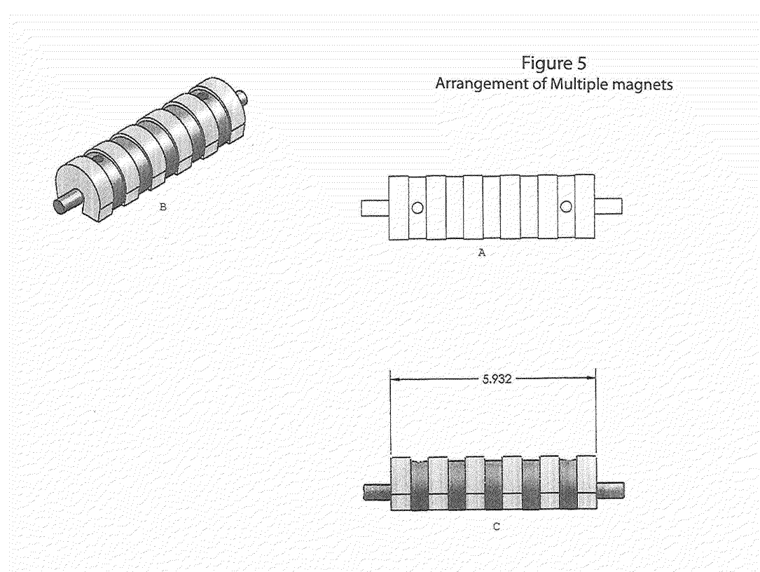

The magnet (30) can be of a suitable shape such as either cylindrical, or horseshoe-shaped, and can be of any suitable configuration and strength to induce a suitable magnetic field in the region of the baseplate (18) and the seeds and plants (34) to be treated. The magnet will swing back and forth across the baseplate in a path of travel defined by the arc of the swing arm (26). The poles of the cylindrical magnet will be parallel to the baseplate at the bottom of the swing. The height of the magnet above the baseplate will be sufficient to induce a quantum resonance field in the region proximate to the seeds or seedlings. In certain embodiments, it is contemplated that the magnet will be positioned between 2 cm and 50 cm above the baseplate in order to induce the desired resonance field. If it is a single magnet, as described here, it should have a suitable magnetic strength. By way of non-limiting example, a magnet in the range of 1-2 Teslas in strength can be employed in certain applications. If multiple magnets such as horseshoe magnets are used, they can be arranged in a suitable manner. One non-limiting example of a suitable arrangement is shown in FIG. 5. Where multiple magnet arrangements are contemplated, the individual magnets can each have a suitable strength such as magnets in the range of 1700 Gauss or 0.4 Tesla. Multiple horseshoe magnets can be arranged in contiguous fashion. It is also contemplated that the multiple horseshoe magnets can be placed in spaced relationship with one another at the end of the fulcrum (28). The non-limiting embodiment depicted in FIG. 5, the horseshoe magnets are mounted on a suitable rod with open ends facing toward the seeds to be treated. Suitable spacers are interposed between the various magnets to complete the array. The individual magnets and spacers can be affixed to the rod by suitable mounting means such as through bolts end nut etc. When a magnet array is employed, in many applications, it is contemplated that the magnet mounting rod will be oriented perpendicular to the arc through which the associated swing arm travels.

It is contemplated that the swing arm (26) with its attached magnet (30) will swing back and forth over the baseplate in an arc A with a suitable periodicity. In various specific embodiments, a periodicity between 0.2 Hz to 1.0 Hz can be employed. In FIG. 1, the swing arm (26) and pivot (28) can be adjusted to provide a periodicity in the desired range. In the various specific embodiments discussed herein, the device has been adjusted such that the swing has a periodicity in this range. It is contemplated that the device will be configured with suitable counterweights and ball bearings or other devices to maintain the motion of the magnet on the swing arm for extended periods. When allowed to swing freely in an arc A above the baseplate, a quantum resonance field is created in the baseplate. The fulcrum or pivot 28 can also be adjusted to provide a defined distance D between the bottom of fulcrum arc A and the seeds or other material to be treated.

Induced by the periodicity of the magnet mounted on the swing arm, electron wave structures and their pulsations are formed in the baseplate and interact constructively or destructively with the vegetative biomaterial on the baseplate. When in constructive interference, the attributes induced in the plants are of a positive nature. When in destructive interference, negative attributes can be produced. The quantum interference field is a localized phenomenon that occurs in the region associated with the interaction of the magnet and the baseplate. The nature of these quantum waves is unique in the aluminum baseplate.

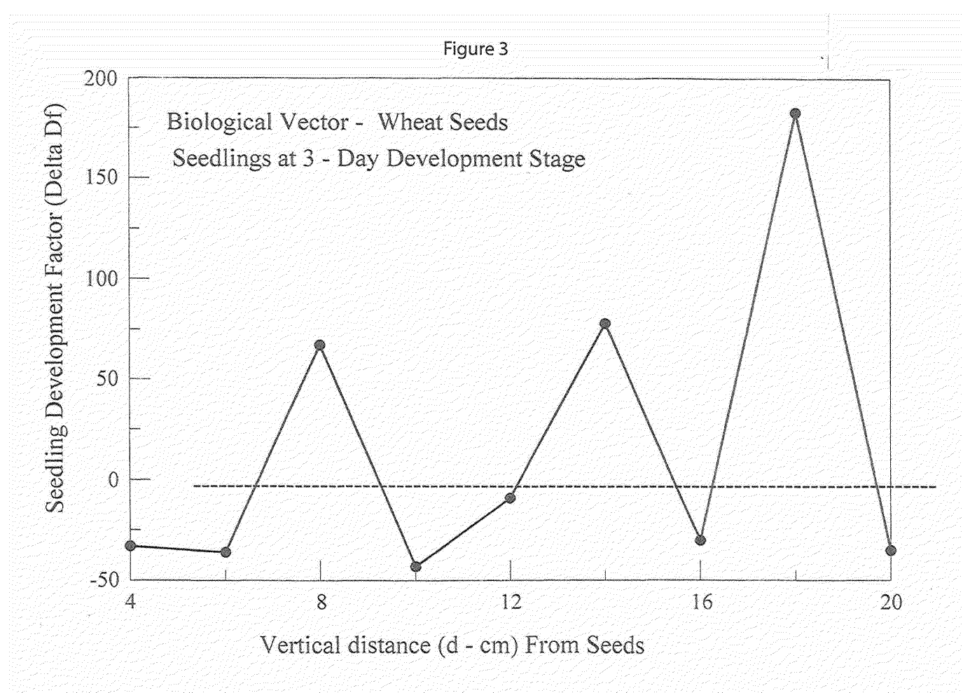

The quantum resonances created by this device and the formation of their pulsations are controlled by varying the pendulum length and/or the distance between the baseplate and the lowest point of the magnet in its arc across the baseplate. In FIG. 2, research shows that as you raise the pendulum, the amplitude of the pulses decreases as the distance between the magnet and baseplate increases. FIG. 3, shows that the effect on the seeds increases as the distance between magnet and baseplate increases. FIG. 3 also shows that the effect of the plasma resonance field does not provide a steady increase in positive enhancements. There are peaks and valleys in the curve, which is characteristic of resonance phenomena, showing both constructive and destructive interference.

In FIG. 2, the quantum mechanical nature of the interaction between the magnet and the baseplate is apparent, with entanglement between the quantum mechanical pulses formed in the baseplate and the magnetic field of the magnet, causing a complete damping of the pendulum swing (the Meissner effect).

Once the vegetative biomaterial, such as seeds, has been subjected to the quantum interference process for the defined interval, the method contemplates allowing the treated material to remain dormant for an interval prior to any subsequent vegetative action. It is contemplated that this dormancy period can be as little as a few hours in the case of already germinated seeds or of already growing plant material. In the case of ungerminated seed material, it is contemplated that the latency period will be an interval of at least 30 days with an upper boundary limit of at least one year. Because of the low metabolic activity in seeds, the interaction between the electron pulses and isomeric transitions going on in the living materials proceeds more slowly. Holding seeds for an interval after treatment, in various instances for at least 30 days before planting facilitates process completion. When already-growing seedlings have been exposed, their metabolism is higher and the waiting period may be shortened. It is believed that the waiting period may be genera specific.

In various specific applications of the invention as presently disclosed, it is contemplated that ungerminated seeds can be from any of a wide number of plant classes. While early investigation has been directed to various fruiting plants such as peppers and tomatoes, as well as to various grain crops such as grasses, wheat, corn, rice, etc., it is also contemplated that other crops can be efficaciously treated by the device and method disclosed herein, including, but not limited to, beans, berries, radishes, carrots, lettuces, and the like. It is also contemplated that ungerminated seeds suitable for treatment by the device and processes disclosed herein can include various seed materials that are either perennial, biennial, or annual bearing materials. In addition to single season crops such as various grains and the like, the seeds or seedlings treated can be arboreal or vine-growing plants, including, but not limited to, both fruit-bearing trees and various trees generally associated with the lumber industry. It is also contemplated that the device and method disclosed herein can be employed successfully on seeds of various grasses including, but not limited to, species such as switch grass useful in production of biofuel, as well as on ornamental plants, and the like.

In a specific embodiment of the method as disclosed herein, it is contemplated that materials to be treated, such as seeds (34), will be placed either directly on the baseplate (18), in a Petri dish, or in other suitable non-magnetic containers (10) configured to sit on the baseplate. The seeds are laid out in an arrangement that will maximize exposure to the pulsed electron wave environment. In many situations, this arrangement will position the seeds in a single layer.

The process can proceed at any suitable external temperature. In various applications, it is contemplated that the external temperature will be at or near ambient room temperature. Similarly, the temperature of the organisms to be treated, such as seeds, plants, etc., will be in the room temperature range. For purposes of this disclosure, ambient or room temperature is defined as being in the range of 22°-30° C.

It is contemplated that the organisms such as seeds or plants will be exposed to the quantum resonance field for intervals sufficient to affect the seeds within the field. Thus, the exposure interval, in its broadest sense, will be governed by principles of dose-response and may vary by factors such as type of organism (plant vs. microorganism) to be treated, and may further vary from species to species within a specific organism type. In various embodiments utilizing seed materials such as corn, rice, wheat, tomatoes, and the like it is contemplated that the exposure interval will be between 10 seconds and 5 minutes. Primarily, in this research, the optimum exposure time has been found to be 45 seconds. However, parametric tests could be conducted to determine the additional characteristics of varying the parameters of both exposure intervals and ideal distance between magnet and baseplate.

Living organisms such as seeds can be processed in either a batch or continuous manner, depending upon the configuration of the treatment device. In one specific embodiment, it is conceived that the seed material will be processed in batch quantities in a single seed depth. However, the device (10) can be configured with a suitable conveyor and multiple magnets to optimize batch treatment or create a continuous treatment process.

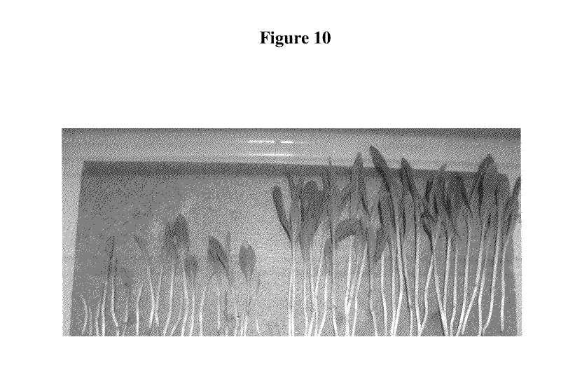

As shown in FIG. 10, the method and device disclosed herein creates seed stock and resulting plant material that exhibits one or more enhanced and desirable characteristics. Such characteristics include, but are not limited to, increased rate of germination, increased growth rate, enhanced drought resistance, enhanced disease resistance, increased tolerance to cold stress, increased biomass in stem and leaf, and increased mass in fruiting material. It is understood that any or all of these features may be exhibited by plant material upon treatment in the manner described herein.

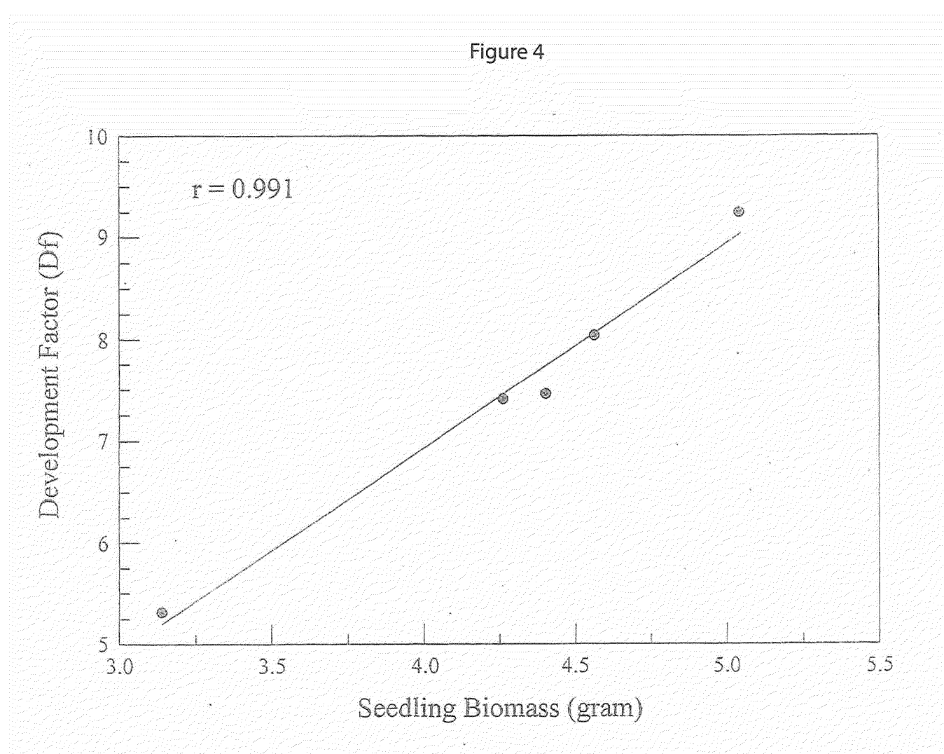

In order to quantify this enhanced plant response, the development factor (D_{f}) can be employed. The (D_{f}), a measure of plant vigor, is a statistical model in which 30 or more seeds are tested and analyzed for the factors of: 1) number germinated, and 2) height of seedling at specified intervals, i.e., 3-5 days post-germination. In most, if not all incidences, treatment with the method and/or device as defined herein results in an increase in germination rate as well as mean height increase in the seedling at the measured intervals. The development factor (D_{f}) or “vigor” shows a marked increase in seeds treated by the method and/or device disclosed herein. As shown in FIG. 4, the development factor (D_{f}) increased nearly 200% when corn seegling biomass was measures at the 12 day development stage after treatment with the process enumerated. Thus, it is contemplated that seeds so treated will exhibit increased development factor, and that the treatment process described herein may be advantageous in increasing the vigor of old seed material, thus rescuing seed material having general germination rates below desired germination rates currently set at 95% or above.

As a general principle, in the device and method disclosed herein, the desired living organism, such as vegetative biomaterial, is exposed to what is designated as a quantum interference process for an interval sufficient to elicit biologically manifested changes in the living organism. It is contemplated that the quantum interference process as disclosed herein is the result of the electron wave pulses in the metal baseplate induced by magnetic periodicity. These generated pulses are a localized phenomenon of quantum mechanics occurring as a result of the association between the magnets and the baseplate.

Without being bound to any theory, there is evidence that the interaction between the induced electron wave pulses and the seed produces changes in the isomeric configuration within the seed. The isomers present in the seed or various treated biomaterials are self-organizing and cyclical with regard to uptake of energy as derived from the biological, metabolic, and nutritional cycles. The seeds, plants, and other biomaterials treated by the process disclosed herein may exhibit higher antioxidant, vitamin, and nutritional content as well as exhibiting the various morphological changes described herein.

The method disclosed herein has a number of potential meaningful applications. The enumerated applications are but examples of advantages and positive outcomes possible with seeds and other biomaterials treated by the method and/or device disclosed herein. It is contemplated that increased germination rate, growth rate, biomass output, yield mass, disease resistance, and stress resistance can impact a variety of economic and ecological factors in salutary ways. It is conceivable that increased vigor in plants resulting from seeds treated by the process disclosed herein can result in a reduction in fertilizer and/or pesticide use in certain situations. It is also contemplated that plants having increased vigor on a crop-wide basis may result in more drought-resistant material requiring less use of water for agriculture.

Additionally, the resulting plant material tends to be denser, thicker, heavier, and simply more abundant. Thus, it is also possible that tree seedlings or tree seeds themselves could be treated by the method disclosed herein, resulting in plant material having stronger and more abundant growth characteristics in rate and/or mass, which would be beneficial in areas such as paper production. Seeds, plants, or microorganisms related to biomass fuel materials such as switch grass could be treated by the method and device disclosed here, resulting in greater biomass available for production of plant-derived fuels. The process and method disclosed herein could be employed on various food crops, including grains, tuberous materials, and seed-bearing plants, including flowers and vegetables. The resulting increase in biomass would be an increase in nutritional value as measured by increased yield and reduced plant damage. The process can be used on rare or extraordinarily valuable plant material or microorganisms from which plant-derived medicines and the like are collected. An increase in the general vigor of the plants so treated can have salutary effects in the ultimate production and availability of desired plant-derived materials such as nutriceuticals, botanically-derived pharmaceuticals, and the like.

Without being bound to any theory, it is believed that the vegetative biomaterial to be treated by the device and method disclosed in the embodiment herein can be any suitable vegetable material capable of or exhibiting metabolic activity. Suitable vegetative biomaterial includes, but is not limited to, various biomaterials in seed or newly germinated seedling form. It is also contemplated that the process could be employed on various bulbs, tubers, and the like, if desired or required. It is also contemplated that the process can be employed on material growing plant tissue and various microorganisms in certain embodiments with beneficial results.

Without being bound to any theory, it is believed that the various seed materials have a native latency period that is variable from species to species. It is believed that even in the dormant state, seed material may exhibit a minimal metabolic rate that can respond to the interaction with the induced resonance generated by the method and device as disclosed herein. Thus, it is possible to stimulate or enhance the internal seed metabolism of the cellular structure contained therein. The induced effects appear to hold and compound during the proposed latency period. Thus, the latency interval permits the cellular structure contained in the seed to fully respond to exposure to the quantum interference process. Evidence of enhanced plant growth characteristics continue to be evident long after the latency period has elapsed.

While the invention has been described in connection with what is presently considered to be the most practical and preferred embodiment, it is to be understood that the invention is not limited to the disclosed embodiment but, on the contrary, is intended to cover various modifications and equivalent arrangements included within the spirit and scope of the appended claims, which scope is to be accorded the broadest interpretation under the laws so as to encompass all modifications and equivalent structures.

In summary, the present disclosure includes but is not limited to the following elements and points.

A method for treating/enhancing living organisms comprising the steps of:

a. Subjecting the organisms to a quantum resonance interference process for an interval sufficient to perturb at least a portion of the biomaterial contained therein, and

b. Allowing the treated vegetative biomaterial to remain quiescent for an interval prior to subsequent action and morphogenesis.

with the result being an increase in at least one of germination rate, growth rate, disease resistance, drought resistance, cold tolerance, biomass output, or increased yield.

The method as described wherein the quantum interference field is produced by the interaction of a magnetic field and a baseplate positioned a variably spaced distance from the magnet, wherein the organisms to be treated are interposed between the magnet and the baseplate in which a quantum resonance field will be set up.

The method as described wherein the quantum resonance field-generating device comprises a pendulum and a baseplate, with the pendulum in proximity to the baseplate, and having at least one magnet attached to the end of the pendulum such that the magnet will traverse an arc defined by the pendulum as it swings back and forth over the baseplate.

The method as described wherein the assembly of magnet and pendulum moving across a baseplate triggers a field of quantum resonance between electrons in the baseplate and the external magnetic field of the magnet on the pendulum.

The method as described wherein the oscillations of a magnet moving across a suitable baseplate produces pulsating electron waves in the baseplate.

The method as described wherein an external magnetic field induces quantum entanglement with the electron wave patterns in a baseplate.

The method as described wherein an external magnetic field induces quantum entanglement with the electron wave patterns in a baseplate.

The method as described wherein the magnetic field induces constructive or destructive interference in a suitable baseplate.

The method as described wherein the magnetic field induces quantum pulses via the tunneling of Cooper pairs.

The method as described wherein the process of subjecting seeds or other living organisms to a quantum resonance interference field consists of introducing the organisms into a device comprising:

a. At least one magnet configured or positioned to produce a cyclically variable magnetic field on one side of a baseplate, and

b. At least one baseplate having a surface upon which biomaterial is exposed to electron waves.

The method as previously disclosed wherein the suitable baseplate material is a metal baseplate having a suitable thickness to generate electron waveforms in the metal.

The method as previously described wherein the living organisms are at least one of seeds, germinated seedlings, plants, microorganisms, and mixtures thereof.

The method as previously described wherein the quiescent interval before germinating seeds that have been treated using the quantum interference process is anywhere between 1 day and 1 year.

The method as previously described wherein seeds, germinated seedlings, plants, and living organisms treated according to the quantum interference process exhibit increased vigor, wherein the increased vigor is expressed in terms of at least one of increased germination rate, growth rate, disease resistance, drought resistance, cold tolerance, biomass output, or increased yield.

The method as previously described wherein the quantum resonance interference field is produced by the interaction of a magnetic field and baseplate.

Biomaterial produced by the method as described wherein at least a portion of the treated material exhibits at least some somatic effects.

A device for treating/enhancing living organisms by a method involving the steps of subjecting the organisms to a quantum resonance interference process for an interval sufficient to perturb at least a portion of the biomaterial contained therein and allowing the treated vegetative biomaterial to remain quiescent for an interval prior to subsequent action and morphogenesis. The device includes at least one organism containing treatment stage; and means for generating a quantum resonance field in proximity to the organism-containing treatment stage. At least the subjecting step occurs while the organisms are present on the treatment stage.

The device as describe previously wherein the means for generating a quantum resonance field in proximity to the organism-containing treatment stage comprises a device configured to generate a periodic magnetic force with respect to the treatment stage.

The device as described previously wherein the periodic magnetic force generator comprises a pendulum affixed to support surface, the pendulum having a support arm, the pendulum having a fulcrum end and an opposed end and at least one magnet connected to the opposed end of the pendulum such that the at least one magnet traverses an arc defined by the pendulum as it swings back and forth. The magnetic force generator also includes a baseplate resting on the support surface. The baseplate is composed of a thin nonmagnetic material and is located in proximity to the magnet. The baseplate can be composed of aluminum. The organism support stage can be an element that overlies the baseplate. Alternately, the organism support stage can be the baseplate.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A method for treating/enhancing living organisms comprising the steps of:
a. Subjecting the organisms to a quantum resonance interference process for an interval sufficient to perturb at least a portion of the biomaterial contained therein, and
b. Allowing the treated vegetative biomaterial to remain quiescent for an interval prior to subsequent action and morphogenesis
with the result being an increase in at least one of germination rate, growth rate, disease resistance, drought resistance, cold tolerance, biomass output, or increased yield.

2. The method of claim 1 wherein the quantum interference field is produced by the interaction of a magnetic field and a baseplate positioned a variably spaced distance from the magnet, wherein the organisms to be treated are interposed between the magnet and the baseplate in which a quantum resonance field will be set up.

3. The method of claim 1 wherein the quantum resonance field-generating device comprises a pendulum and a baseplate, with the pendulum in proximity to the baseplate, and having at least one magnet attached to the end of the pendulum such that the magnet will traverse an arc defined by the pendulum as it swings back and forth over the baseplate.

4. The method of claim 1 wherein the assembly of magnet and pendulum moving across a baseplate triggers a field of quantum resonance between electrons in the baseplate and the external magnetic field of the magnet on the pendulum.

5. The method of claim 3 wherein the oscillations of a magnet moving across a suitable baseplate produces pulsating electron waves in the baseplate.

6. The method of claim 4 wherein an external magnetic field induces quantum entanglement with the electron wave patterns in a baseplate.

7. The method of claim 4 wherein the magnetic field induces constructive or destructive interference in a suitable baseplate.

8. The method of claim 4 wherein the magnetic field induces quantum pulses via the tunneling of Cooper pairs.

9. The method of claim 1 wherein the process of subjecting seeds or other living organisms to a quantum resonance interference field consists of introducing the organisms into a device comprising:
a. At least one magnet configured or positioned to produce a cyclically variable magnetic field on one side of a baseplate, and
b. At least one baseplate having a surface upon which biomaterial is exposed to electron waves.

10. The method of claim 3 wherein the suitable baseplate material is a metal baseplate having a suitable thickness to generate electron waveforms in the metal.

11. The method of claim 9 wherein the living organisms are at least one of seeds, germinated seedlings, plants, microorganisms, and mixtures thereof.

12. The method of claim 1 wherein the quiescent interval before germinating seeds that have been treated using the quantum interference process is anywhere between 1 day and 1 year.

13. The method of claim 9 wherein seeds, germinated seedlings, plants, and living organisms treated according to the quantum interference process exhibit increased vigor, wherein the increased vigor is expressed in terms of at least one of increased germination rate, growth rate, disease resistance, drought resistance, cold tolerance, biomass output, or increased yield.

14. Biomaterial produced by the method of claim 1 wherein at least a portion of the treated material exhibits at least some somatic effects.

15. The method of claim 1 wherein the quantum resonance interference field is produced by the interaction of a magnetic field and a baseplate.

16. A device for treating/enhancing living organisms by a method involving the steps of subjecting the organisms to a quantum resonance interference process for an interval sufficient to perturb at least a portion of the biomaterial contained therein and allowing the treated vegetative biomaterial to remain quiescent for an interval prior to subsequent action and morphogenesis, the device comprising:
At least one organism containing treatment stage; and
Means for generating a quantum resonance field in proximity to the organism-containing treatment stage;
wherein at least the subjecting step occurs while the organisms are present on the treatment stage.

17. The device of claim 16 wherein the means for generating a quantum resonance field in proximity to the organism-containing treatment stage comprises:
a device configured to generate a periodic magnetic force with respect to the treatment stage.

18. The device of claim 17 wherein the periodic magnetic force generator comprises:
A pendulum affixed to support surface, the pendulum having a support arm, the pendulum having a fulcrum end and an opposed end;
At least one magnet connected to the opposed end of the pendulum such that the at least one magnet traverses an arc defined by the pendulum as it swings back and forth;
A baseplate resting on the support surface, the baseplate composed of a thin nonmagnetic material the base plate located in proximity to the magnet.

19. The device of claim 18 wherein the baseplate is composed of aluminum and wherein the organism support stage overlies the baseplate.

20. The device of claim 18 wherein the baseplate is composed of aluminum and wherein the organism support stage is the baseplate.
